(19) United States
(12) Patent Application Publication
(10) Pub. No.: US 2018/0244918 A1
(43) Pub. Date: Aug. 30, 2018

(54) ENHANCED POLYAMIDE BASE RESIN FOR ENGINEERING PLASTICS FORMULATIONS

(71) Applicant: AdvanSix Resins & Chemicals LLC, Parsippany, NJ (US)

(72) Inventors: Timothy Bauer, Colonial Heights, VA (US); Haiming Chen, Shanghai (CN); John V. Facinelli, Morristown, NJ (US); Min Wang, Shanghai (CN)

(21) Appl. No.: 15/903,185

(22) Filed: Feb. 23, 2018

(30) Foreign Application Priority Data
Feb. 24, 2017 (CN) PCT/CN2017/074718
Sep. 1, 2017 (CN) PCT/CN2017/100107

(51) Int. Cl. C08L 77/06; C08G 69/14; C08G 69/26; C08J 5/04; C08J 5/12

(52) U.S. Cl. CPC C08L 77/06; C08G 69/14; C08G 69/26; C08J 2377/06; C08J 5/12; C08J 5/043; C08J 5/042

(57) ABSTRACT

Polyamide base resins with improved crystallization dynamics for the production of reinforced polyamide compositions having improved surface, shrink, warpage and mechanical properties such as toughness. The polyamide base resins are copolymers of polyamide 6 and polyamide 66, formed of ratios that are tailored to reduce the crystallization rate and final crystallization extent when used in melt processing to produce glass filled articles. The copolymers demonstrate improved polyamide morphology dynamics that in turn impart improved final properties in reinforced molded articles, such as improved surface finish, improved toughness/impact resistance, reduced warpage, and more symmetrical shrinkage properties.

### FIELD

The present disclosure relates to polyamide materials and, in particular, to a copolymer of polyamide 6 and polyamide 66 for use as base resin for fiber reinforced manufactured plastic articles, for example.

### BACKGROUND

Currently, both polyamide 6 (PA 6) and polyamide 66 (PA 66) homopolymers are used as base resins for fiber filled or reinforced compositions of the type that are processed, typically via injection molding, for example, into finished articles that are commonly used in automotive, consumer goods, power tools, electrical, electronic, and other applications.

For example, polyamide 6 has good mechanical strength, thermal stability and chemical resistance, and is one of the most widely used engineering plastics, especially in the automobile industry worldwide. Polyamide 6 is commonly compounded with glass fiber (GF) and/or other additives such as carbon black, impact modifiers and processing aids, for example. However, currently in the automobile industry, new requirements are either now present or are foreseen, such as the need for properties such as better surface finish, lower shrinkage and warpage, and higher toughness.

For automobile parts producers, for example, improving the surface finish of plastic finished parts is highly desired. Improved surface finish may be described as a smooth surface with less “floating” of glass fibers in or on the surface of the molded parts, which will reduce the post treatment steps of the articles and the dependence on paint or other coverings, thereby also making the product more environmentally friendly and saving costs. Automobile parts producers also desire high dimensional accuracy of finished articles and, in this context, lower warpage is another highly desirable property of automobile parts, especially for larger sized parts.

Current base resins based on polyamide 6 and polyamide 66 homopolymers typically cannot meet the increasingly stringent requirements such as those discussed above. For example, certain deficiencies in the melt processability of such compositions, as well as certain deficiencies in the resulting properties of the final products, can result in such compositions not being fit or being desirable for their intended use. For example, high amounts of glass fiber in polyamide 6 or polyamide 66-based compounds can result in poor surface finish for final molded parts. Other common deficiencies for compositions based on polyamide 6 or polyamide 66 include differential shrinkage, leading to part warpage and low impact strength. The relatively rapid crystallization of polyamide 6 and polyamide 66 homopolymers is typically a root cause for these deficiencies.

What is needed is an improvement over the foregoing.

### SUMMARY

The present disclosure provides polyamide base resins with improved crystallization dynamics for the production of reinforced polyamide compositions having improved surface, shrink, warpage and mechanical properties such as toughness. The polyamide base resins are copolymers of polyamide 6 and polyamide 66, formed of ratios that are tailored to reduce the crystallization rate and final crystallization extent when used in melt processing to produce glass filled articles. The copolymers demonstrate improved polyamide morphology dynamics that in turn impart improved final properties in reinforced molded articles, such as improved surface finish, improved toughness/impact resistance, reduced warpage, and more symmetrical shrinkage properties.

For example, in automobile parts, the low warpage, low shrinkage and high toughness properties provided to finished articles made with the present base resins enable the production of relatively larger sized parts such as pillars, frame reinforcements, and door components. The smooth surface finish of finished parts made from the present base resins enable the production of parts that are visibly exposed, such as body panels and bumpers, for example, and the relatively wide processing window enabled by the relatively slower crystallization time of the present base resins allows for relatively high reinforcement loading, such as with glass fibers, for increased toughness while also preserving a smooth surface finish.

In addition to automobile parts, manufactured articles made with the present base resin may be used in applications such as appliances, electrical equipment, and building and construction components, for example.

In one form thereof, the present disclosure provides a polymeric base composition for use in manufacturing a finished article via melt processing, the polymeric base composition including at least one polyamide 6/66 copolymer polymerized from caprolactam and adipic acid/hexamethylenediamine monomers and including between 70 mol. % and 99 mol. % monomers based on caprolactam and between 1 mol. % and 30 mol. % monomers based on adipic acid and hexamethylenediamine, based on the total moles of caprolactam and adipic acid/hexamethylenediamine monomers; and at least one reinforcement component.

In other embodiments, the polyamide 6/66 copolymer includes between 70 mol. % and 96 mol. % monomers based on caprolactam and between 4 mol. % and 30 mol. % monomers based on adipic acid and hexamethylenediamine, based on the total moles of caprolactam and adipic acid/hexamethylenediamine monomers, based on the total moles of caprolactam and adipic acid/hexamethylenediamine monomers.

The polyamide 6/66 copolymer may have a relative viscosity (RV) of 2.0 to 3.0 as determined by a viscometer according to ASTM D798. The polyamide 6/66 copolymer may have a melt point, measured by Differential Scanning calorimetry (DSC) using ASTM D3418, between 190° C. and 225° C. The polyamide 6/66 copolymer may have a crystallization temperature, measured by Differential Scanning calorimetry (DSC) using ASTM D3418, between 150° C. and 170° C. The polyamide 6/66 copolymer may have a crystallization time, as determined by differential scanning calorimetry (DSC) using ASTM E2070, between 1 min and 14 min.

The reinforcement component of the polymeric base composition may include glass fibers. The reinforcement component of the polymeric base composition may include carbon fibers. The reinforcement component may be present in an amount between 5% and 85%, based on the total weight of the polyamide 6/66 copolymer and the reinforcement component.

In another form thereof, the present disclosure provides an article formed via a melt processing method, the article including at least one polyamide 6/66 copolymer polymerized from caprolactam and adipic acid/hexamethylenediamine monomers and including between 70 mol. % and 99 mol. % monomers based on caprolactam and between 1 mol. % and 30 mol. % monomers based on adipic acid and hexamethylenediamine, based on the total moles of caprolactam and adipic acid/hexamethylenediamine monomers; and at least one reinforcement component.

In other embodiments, the polyamide 6/66 copolymer may include between 70 mol. % and 96 mol. % monomers based on caprolactam and between 4 mol. % and 30 mol. % monomers based on adipic acid and hexamethylenediamine, based on the total moles of caprolactam and adipic acid/hexamethylenediamine monomers.

The article may have a surface with a measured gloss at a 60° angle of incidence according to ASTM D-523 between 50.0 and 95.0. The article may have a conditioned toughness determined according to ASTM D-256 at 23° C. between 180 J/m and 500 J/m. The article may have a dry condition toughness determined according to ASTM D-256 at 23° C. between 30 J/m and 250 J/m.

In further embodiments, the article may have a measured initial shrinkage vertical to the flow direction (Ws) according to ASTM D-955 between 0.45% and 1.2%. The article may have a measured initial shrinkage parallel to the flow direction (Ls) according to ASTM D-955 between 0.10% and 1.0%.

The reinforcement component of the article may include glass fibers. The reinforcement component of the article may include carbon fibers and the article may have a flexural modulus according to ASTM D-790 between 18000 and 30000 MPa. The reinforcement component of the article may include carbon fibers and the article may have a Young's modulus according to ASTM D-638 between 20000 and 40000 MPa. The reinforcement component of the article may include carbon fibers and the article may have a tensile strength according to ASTM D-638 between 500 and 3000 MPa.

### BRIEF DESCRIPTION OF THE DRAWINGS

The above mentioned and other features of the disclosure, and the manner of attaining them, will become more apparent and the disclosure itself will be better understood by reference to the following description of embodiments of the disclosure taken in conjunction with the accompanying drawings.

FIG. 1 is related to Example 1 and provides the crystallization rate as a function of temperature for various formulations.

FIG. 2A is related to Example 4 and provides the melt temperature for copolymers formed from compositions having varying levels of monomers.

FIG. 2B is related to Example 4 and provides the peak isothermal crystallization time (in minutes) at 170° C. for copolymers formed from compositions having varying levels of monomers.

FIG. 3 is related to Example 4 and provides the ¹³ C NMR spectra for Ex. 3B and Comp. Ex. 3 copolymers formed from compositions having varying levels of monomers.

FIG. 4 is related to Example 4 and provides the degree of randomness for copolymers formed from compositions having varying levels of monomers.

FIG. 5 is related to Example 5 and provides warpage comparison data.

FIG. 6 is related to Example 5 and provides shrinkage data.

FIG. 7 is related to Example 10 and provides surface appearance data.

FIG. 8 is related to Example 10 and provides gloss data.

FIG. 9 is related to Example 11 and provides room temperature notched izod impact strength data.

FIG. 10 is related to Example 11 and provides −40° C. notched izod impact strength data.

FIG. 11 is related to Example 12 and provides gloss data.

FIG. 12 is related to Example 13 and shows warpage data.

FIG. 13A is related to Example 14 and provides initial shrinkage data.

FIG. 13B is related to Example 14 and provides 24 hours shrinkage data.

FIG. 13C is related to Example 14 and provides 48 hours shrinkage data.

FIG. 14 is a cross section of an exemplary polymer article.

FIG. 15 is a cross section of another exemplary polymer article.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate one or more embodiment of the disclosure, and such exemplifications are not to be construed as limiting the scope of the disclosure in any manner.

### DETAILED DESCRIPTION

The present disclosure provides polyamide base resins in the form of copolymers of polyamide 6 and polyamide 66 (polyamide 6/66 copolymers) that are synthesized from caprolactam monomers and adipic acid/hexamethylenediamine monomers. The adipic acid and hexamethylenediamine components of the adipic acid/hexamethylenediamine monomers may be provided in a salt of 1:1 molar proportion, referred to as “AH salt”, which may be either in solid form or in the form of an aqueous solution. The terms “adipic acid/hexamethylenediamine” and “AH salt” are used interchangeably herein.

I. Preparation of Polyamide 6/66 Copolymers.

Caprolactam is traditionally used to form polyamide 6 via ring opening hydrolysis, followed by polymerization. AH salts are traditionally used to form polyamide 66 via condensation polymerization. In the present process, caprolactam monomers and AH salt monomers are polymerized together to produce polyamide 6/66 copolymers including a majority component of monomers based on caprolactam and a minority component of monomers based on AH salt, i.e., adipic acid and hexamethylenediamine. As discussed further below, in the present polyamide 6/66 copolymers, the polymer chains include monomers, or repeating units, based on caprolactam and monomers, or repeating units, based on adipic acid/hexamethylenediamine which are mutually present in the polymer chains according to a random or near random distribution.

In some embodiments, in the present polyamide 6/66 copolymers, the caprolactam monomers, which also may be referred to as the polyamide 6 monomers, make up as little as 70 mol. %, 75 mol. %, 80 mol. %, 84 mol. %, 90 mol. %, 94 mol. %, 95 mol. %, 96 mol. %, or as great as 97 mol. %, 98 mol. %, or 99 mol. %, of the total moles of caprolactam and AH salt monomers, or within any range defined between any two of the foregoing values, such as 70 mol. % to 99 mol. %, 75 mol. % to 99 mol. %, 80 mol. % to 99 mol. %, 84 mol. % to 99 mol. %, 90 mol. % to 99 mol. %, 94 mol. % to 99 mol. %, 94 mol. % to 96 mol. %, or 70 mol. % to 96 mol. %, for example.

In some embodiments, in the present polyamide 6/66 copolymers, the AH salt monomers, which also may be referred to as the polyamide 66 monomers, make up as little as 1 mol. %, 2 mol. %, 3 mol. %, 4 mol. %, 5 mol. %, or as great as 8 mol. %, 10 mol. %, 12 mol. %, 15 mol. %, 20 mol. %, 25 mol. % or 30 mol. % of the total moles of caprolactam and AH salt monomers, or within any range defined between any two of the foregoing values, such as 1 mol. % to 30 mol. %, 2 mol. % to 25 mol. %, 3 mol. % to 20 mol. %, 4 mol. % to 15 mol. %, 5 mol. % to 12 mol. %, 4 mol. % to 30 mol. %, for example.

To form the present polyamide 6/66 copolymers, caprolactam and AH salt are blended together at elevated temperatures, such as low as about 135° C., 145° C., 155° C., or 165° C., or as great as 170° C., 175° C., or 180° C., or within any range defined between any two of the foregoing values, such 150° C. to 170° C., or 155° C. to 180° C. for example. The caprolactam and AH salt may be mildly agitated during heating to provide more uniform heat transfer and mixing. The AH salt may be combined with the caprolactam as a dry powder, or may be combined with the caprolactam as an aqueous solution, such as an aqueous solution containing as little as about 50 wt. %, 52 wt. %, 55 wt. %, as great as 58 wt. %, 60 wt. % solids, or within any range defined between any two of the foregoing values, such 50 wt.° A to 60 wt. % or 55 wt.° A to 60 wt. %, for example. Further, particularly when AH salt is used as a dry powder, the caprolactam and AH salt may be blended in the presence of added water.

The mixture of caprolactam and AH salt, and optionally water, is polymerized to form the polyamide composition. The polymerization may be carried out using a batch continuously stirred tank reactor (CSTR), a VK tube, or by using a continuous polymerization train, for example.

II. Properties of the Polyamide 6/66 Copolymers.

The polyamide 6/66 copolymers may have a relative viscosity (RV) as low as 2.0, 2.1, or 2.2, or as high as 2.5, 2.7, or 3.0, or within any range defined between any two of the foregoing values, such as 2.0 to 3.0, 2.1 to 2.5, or 2.2 to 2.7, for example. Relative viscosity is mainly determined by the molecular weight and molecular weight distribution.

In some embodiments, the polyamide 6/66 copolymers have a relatively low melt point as measured by Differential Scanning calorimetry (DSC) using ASTM D3418 compared to either a polyamide 6 or polyamide 66 homopolymer, as well as a polyamide compositions that are formed from a physical melt blend of polyamide 6 and polyamide 66 homopolymers. In particular, the polyamide 6/66 copolymers may have a melt point as low as 190° C., 195° C., 200° C., or as high as 205° C., 210° C., 215° C., 220° C., 225° C,or within any range defined between any two of the foregoing values, such as 190° C. to 225° C., 195° C. to 215° C., or 200° C. to 210° C., for example.

In some embodiments, the polyamide 6/66 copolymers have a relatively low crystallization temperature as measured by Differential Scanning calorimetry (DSC) using ASTM D3418 compared to either a polyamide 6 or polyamide 66 homopolymer, as well as polyamide compositions that are formed from a physical melt blend of polyamide 6 and polyamide 66 homopolymers. In particular, the polyamide 6/66 copolymers may have a crystallization temperature as low as 135° C., 145° C., 155° C., 165° C., or as high as 170° C., 175° C., 180° C., or within any range defined between any two of the foregoing values, such as 135° C. to 180° C., 145° C. to 175° C., or 155° C. to 170° C., for example.

In some embodiments, the polyamide 6/66 copolymers have a relatively long isothermal crystallization time as measured by Differential Scanning calorimetry (DSC) using ASTM E2070 compared to either a polyamide 6 or polyamide 66 homopolymer, as well as polyamide compositions that are formed from a physical melt blend of polyamide 6 and polyamide 66 homopolymers. In particular, the polyamide 6/66 copolymers may have an isothermal crystallization time as little as 1 min, 2 min, 4 min, 6 min, or as high as 8 min, 10 min, 12 min, 14 min or within any range defined between any two of the foregoing values, such as 1 min to 14 min, 2 min to 12 min, or 4 min to 8 min, for example. In some embodiments, isothermal crystallization was performed at 170° C. to measure isothermal crystallization time, among other properties.

The polyamide 6/66 copolymers may have a relatively high degree of randomness in connection with the monomers or repeating units based on caprolactam and the monomers or repeating units based on AH salt. In some exemplary embodiments, the degree of randomness is calculated (with equations I and II shown below) from the intensities of carbonyl peaks in the spectra obtained by.

$$\begin{matrix}Polyamide 6.6 mol \% = \frac{{I}_{PA 6.6 - PA 6} + {I}_{PA 6.6 - PA 6.6}}{{I}_{total}} \times 100 \% & ( I ) \\ Degree of randomness ( R ) = \frac{{I}_{PA 6 - PA 6.6}}{{I}_{PA 6 - PA 6} + {I}_{PA 6 - PA 6.6}} + \frac{2 {I}_{PA 6.6 - PA 6}}{{I}_{PA 6.6 - PA 6} + {I}_{PA 6.6 - PA 6.6}} & ( II )\end{matrix}$$

In some exemplary embodiments, the measured degree of randomness may be as little as 0.4, 0.55, 0.7, as high as 0.975, 1.00, 1.25, or within any range defined by any two of the foregoing values, such as 0.6 to 1.1, 0.82 to 1.01, or 0.95 to 1.01, for example.

Without wishing to be held to any particular theory, it is believed that copolymerizing monomers of caprolactam and AH salt in the relative amounts and using the conditions according to the present disclosure provides a highly randomized distribution of the AH salt monomers and the caprolactam monomers in the copolymer chains.

III. Preparation of Manufactured Articles Using Polyamide 6/66 Copolymers.

After the polyamide 6/66 copolymer is produced as discussed above, same may be combined with a reinforcement component, such as glass and/or mineral fibers, and/or other additives to form a ready to process reinforced polymer base resin in a suitable form such as pellets, bars, or sheets, for example, for further melt processing. Alternatively, the reinforcement component may be added or combined with the polyamide 6/66 copolymer during the melt processing operation, such as injection molding, extrusion, hot pressing, sheet molding compound (SMC), resin transfer molding (RTM), vacuum bag molding, continuous rolling molding, pultrusion molding, twining molding, or other suitable techniques by which the finished manufactured article is formed. Descriptions of exemplary manufacturing methods follow below.

Injection molding. Injection molding is one of the most commonly used manufacturing processes for polymer composite articles, and is conducted with an injection machine and a mold. The polymer with reinforcement and additives from a hopper is melted in an extruder, and then injected to the mold with a suitable pressure, temperature and speed. Finally, the articles are cooled and released from the mold. Good flowability of the base resin is important for injection molding, and the copolymers disclosed herein have good flowability, making them suitable for injection molding processes.

Extrusion. Extrusion is one of the most commonly used manufacturing processes for polymer composite articles. The equipment includes an extruder, cooling equipment, traction equipment and cutting equipment. The polymer with reinforcement and additives from a hopper is melted in the extruder, and is then pulled from a die of the extruder in a specific shape by traction equipment, followed by cooling in cooling equipment, such as via a water bath and/or air cooling. The present copolymers have suitable melt strength and viscosity for extrusion processes.

Hot pressing. Hot Pressing is widely used in the manufacturing of fiber reinforced articles. The general process of hot pressing includes the steps of placing reinforcement material such as chopped fibers, polymer pellets (or powder), and additives in an open mold, and then pressing in suitable press and at a suitable temperature, followed by mold releasing and cooling, after which the final molded articles are recovered. As opposed to injection molding and extrusion, in hot pressing the melting of the polymer and the molding of the articles occur at the same time. The present copolymers have lower melting temperatures than known PA6 and/or PA66 polymers and are therefore more suitable for use in hot pressing methods.

Sheet molding compounding (SMC). SMC is widely used for manufacturing articles using unsaturated polymers, and is a suitable manufacturing process for thermal plastic-based articles. A prepreg tape is made in a first step, followed by press molding in a second step, followed by cutting and polishing to a desired shape. The high flowability and low melting temperature of the present copolymers make them suitable for SMC, and SMC may be used for manufacturing articles reinforced with continuous long fibers or fabrics.

Resin transfer molding (RTM). RTM is widely used for the manufacturing of large sized articles, and is suitable for manufacturing articles that are reinforced with continuous long fibers or fabrics. The fibers or fabrics are placed in a mold in a first step, and a melted polymer is injected to the mold in a second step to wet the fibers or fabrics, following by molding in a third step, and finishing with cooling and mold release.

Vacuum bag molding. In this process, reinforcing fibers or fabrics are uniformly placed in a bag in a first step, followed by subjecting the bag to a vacuum in a second step, and injecting the polymer into the bag to wet the fibers or fabrics in third step and curing in a fourth step before cooling and mold release. Generally, vacuum bag molding is used for fabrics reinforced polymer articles manufacturing. The articles have extremely high performance for high end applications, such as aircraft components and parts for high-end automobiles.

Continuous rolling molding. Continuous rolling molding is used for continuous long fiber reinforced polymer plates or prepreg tape manufacturing. Continuous long fibers or fabrics are pulled from a roller to a melted polymer bath in first step, followed by on-line cooling and pressing in second step, and winding in a third step. The lower melting temperature of the present copolymers makes them suitable for continuous rolling molding processes.

The polyamide 6/66 copolymer of the preset disclosure could be used alone or together in a blend with one or more other, second polymers to form a polymer alloy as the base or matrix resin. Other polymers may include other types of polyamides such as PA 6 homopolymer, acrylonitrile butadiene styrene, polyethylene, polypropylene, acrylonitrile styrene acrylate copolymer, polyphenylene sulfide, polyphenylene oxide, and the other polymers that are suitably combinable with the polyamide 6/66 copolymer.

Suitable glass and/or mineral fibers and/or carbon fibers include short fibers, sometimes referred to as “chopped” fibers, having an average length as little as 0.25 mm, 0.5 mm, or 1 mm, or as long as 2.5 mm, 5 mm, or 5.5 mm, or within any range defined between any two of the foregoing values, or long fibers having an average length as little as 6 mm, 8 mm, or 10 mm, or as long as 15 mm, 20 mm, or 25 mm, or within any range defined between any two of the foregoing values. For both short and long fibers, the average diameters of the fibers may be as little as 0.1 μm, 1 μm, 10 μm, 25 μm, or as long as 50 μm, 75 μm, 100 μm, or 150 μm, or may be within any range defined between any two of the foregoing values.

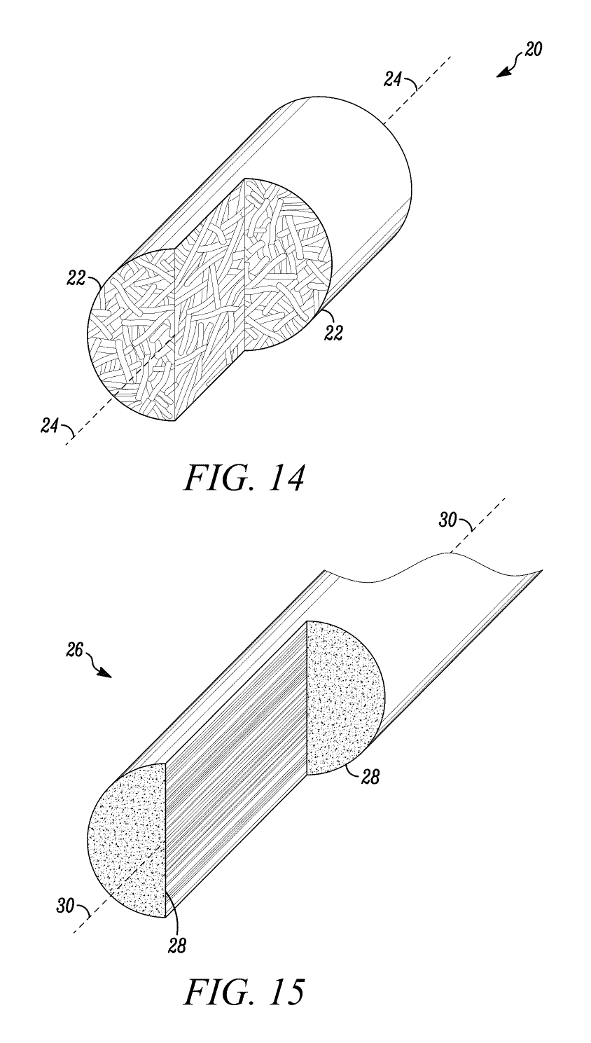

Referring to FIG. 14, a cross section of a polymer article 20 is shown, including long fibers 22 of the foregoing size. As may be seen from FIG. 14, the long fibers 22 may be essentially randomly oriented, and do not necessarily extend parallel with the long axis 24 of the polymer article 20.

In an alternate embodiment, shown in FIG. 15, a cross section of a polymer article 26 is shown, including continuous long fibers 28, also having an average length between 6 mm and 25 mm and average diameters of between 0.1 μm and 150 μm, though which are also oriented in parallel both with each other and with the long axis 30 of the article 26. Optionally, short fibers, long fibers, continuous long fibers, fabrics and fiber powders may be used in combination.

Further, other reinforcement components, such as fiber powders, fabrics, as well as carbon nanotubes, nanoglass fibers and nanocarbon fibers may also be used. Nanoscale fibers may also be used, having diameters as little as 0.1 nm, 1 nm, 5 nm, or 10 nm, or as great as 25 nm, 50 nm, or 100 nm, or within any range defined between any pair of the foregoing values.

Exemplary loading amounts of the reinforcement component, e.g., glass and/or mineral fibers and/or carbon fibers, may be as little as 5 wt. %, 15 wt. %, or 30 wt. %, or as great as 45 wt. %, 65 wt. %, or 85 wt. %, or may be within any range defined between any two of the forgoing values, such as between 5 wt. % and 60 wt. %, 15 wt. % and 50 wt. %, and 30 wt. % and 45 wt. %, based on the total weight of the polyamide 6/66 copolymer and the reinforcement component.

Other reinforcement components may alternatively, or additionally, include one or more types of particulate fillers, for example, having an average particle size as little as 10 nm, 1 μm, or 8 μm, or as great as 15 μm, 100 μm, or 500 μm, or may be between any pair of the forgoing values, such as between 10 nm and 15 μm, 8μm and 15 μm, and 8μm and 500 μm, based on the total weight of the polyamide 6/66 copolymer and the filler.

Other additives may include pigments, lubricants, heat stabilizers, anti-wear additives, ultraviolet (UV) stabilizers, flexibilizers, nucleating additives, fire retardants, antioxidants, antistatic additives, and other suitable additives. Exemplary heat stabilizers include copper iodide, potassium iodide, potassium bromide, sodium iodide, potassium chloride, other copper halides, and other metallic halides. Exemplary lubricants include ethylene bis stearamide (“EBS”), other organic amides, aluminum stearate, zinc stearate, calcium stearate, other metallic stearates, and other metallic fatty acids. Exemplary anti-wear additives include perfluoropolyether, polytetrafluoroethylene, functional and non-functional polydimethylsiloxane, graphite, molybdenum disulfide, and silicone oil. Exemplary UV stabilizers may include a hindered amine light stabilizer (“HALS”), such as N,N′-Bis-2,2,6,6-tetramethyl-4-piperidinyl-1,3-benzene dicarboxamide, for example. Exemplary flexibilizers may include polyolefins and polystyrene flexibilizers, such as polyolefin elastomers, for example. Exemplary nucleating additives may include small size talcum powder, silicon dioxide powder, aluminium oxide powder and montmorillonoid powder. Exemplary fire retardants may include tripolycyanamide, antimonous oxide, zinc borate, and brominated flame retardant, such as decabromodiphenyl ether and decabromodiphenyl ethane, for example; and may also include phosphorus flame retardants, such as red phosphorus, for example. Exemplary antioxidants include amine antioxidants, such as diphenylamine, p-phenylenediamine, and dihydro-quinoline; and may also include hindered phenol antioxidants, such as 2,6-di-tert-butyl-4-methylphenol and pentaerythrotol, for example. Exemplary antistatic additives include alkyl sulfonic acid alkali metal salt and aminodithioformic acid alkali metal salt, for example.

In one embodiment, the polyamide 6/66 copolymer composition of the preset disclosure, which may be used to product manufactured articles in the manner described below, may include less than 5 wt. %, less than 3 wt. %, or less than 1 wt. % of additional polymers other than polyamide 6/66 copolymer. For example, the polyamide 6/66 copolymer composition may include less than 5 wt. %, less than 3 wt. %, or less than 1 wt. % of a copolymer based on ethylene and butylene, for example.

IV. Properties of Manufactured Articles.

In some exemplary embodiments, a finished part formed from the present polyamide 6/66 copolymer base resin composition has a relatively high flexural modulus. The flexural modulus may be measured according to ASTM D 790 in some embodiments. In some exemplary embodiments, the measured flexural modulus may be as little as 536 MPa, 1887 MPa, 2481 MPa, as high as 20000 MPa, 25000 MPa, 30000 MPa, or within any range defined by any two of the foregoing values, such as 536 MPa to 30000 MPa, or 2481 MPa to 25000 MPa, for example.

In one exemplary embodiment, a finished part formed from the present polyamide 6/66 copolymer base resin composition reinforced by carbon fibers has a higher flexural modulus compared with the glass and/or mineral fibers reinforced one. The flexural modulus may be measured according to ASTM D 790 in some embodiments. In one exemplary embodiment, the measured storage modulus may be as little as 18000 MPa, 20000 MPa, 22000 MPa, as high as 25000 MPa, 28000 MPa, 30000 MPa, or within any range defined by any two of the foregoing values, such as 18000 MPa to 30000 MPa, 20000 MPA to 28000, or 22000 MPa to 25000 MPa, for example.

In some exemplary embodiments, a finished part formed from the present polyamide 6/66 copolymer base resin composition has a relatively high Young's modulus. The Young's modulus may be measured according to ASTM D 638 in some embodiments. In some exemplary embodiments, the measured Young's modulus may be as little as 500MPa, 2000 MPa, 2500 MPa, as high as 30000 MPa, 35000 MPa, 40000 MPa, or within any range defined by any two of the foregoing values, such as 500 MPa to 30000 MPa, or 2000 MPa to 40000 MPa, for example.

In one exemplary embodiment, a finished part formed from the present polyamide 6/66 copolymer base resin composition reinforced by carbon fibers has a higher Young's modulus compared with the glass and/or mineral fibers reinforced one. The Young's modulus may be measured according to ASTM D 638 in some embodiments. In one exemplary embodiment, the measured Young's modulus may be as little as 20000 MPa, 22000 MPa, 25000 MPa, as high as 30000 MPa, 35000 MPa, 40000 MPa, or within any range defined by any two of the foregoing values, such as 20000 MPa to 30000 MPa, or 12000 MPa to 40000 MPa, for example.

In some exemplary embodiments, a finished part formed from the present polyamide 6/66 copolymer base resin composition has a relatively high tensile strength. The tensile strength may be measured according to ASTM D 638 in some embodiments. In some exemplary embodiments, the measured tensile strength may be as little as 30MPa, 80 MPa, 120 MPa, as high as 1500 MPa, 2500 MPa, 3000 MPa, or within any range defined by any two of the foregoing values, such as 80 MPa to 2500 MPa, or 120 MPa to 1000 MPa, for example.

In one exemplary embodiment, a finished part formed from the present polyamide 6/66 copolymer base resin composition reinforced by carbon fibers has a higher tensile strength compared with the glass and/or mineral fibers reinforced one. The tensile strength may be measured according to ASTM D 638 in some embodiments. In one exemplary embodiment, the measured tensile strength may be as little as 500 MPa, 800 MPa, 1000 MPa, as high as 1500 MPa, 2500 MPa, 3000 MPa, or within any range defined by any two of the foregoing values, such as 500 MPa to 3000 MPa, or 1000 MPa to 2500 MPa, for example.

The claimed polyamide 6/66 copolymer has lower warpage compared with polyamide 6 and polyamide 66 homopolymers. Warpage was measured according to the following method. Pellets are pre-dried @ 80° C. for 6h before injection molding. Molding plates with a size of 100*100*2 mm are used and the general injection molding parameters are as follows: injection temperature 280° C., molding temperature 100° C. Fix one side of the plates to a flat and smooth desktop, measure the distance between the other side of the plate and the desktop. Testing conditions 23° C. and 50% relative humidity. 10 plates were tested for each sample, and an average value is calculated and recorded. The measured warpage may be as little as 1.0 mm, 2.0 mm, 3.0 mm, as high as 5.0 mm, 5.5 mm, 6.0 mm, or within any range defined by any two of the foregoing values, such as 1.0 mm to 6.0 mm, or 2.0 mm to 5.0 mm, for example.

In some exemplary embodiments, a finished part formed from the present polyamide 6/66 copolymer base resin composition has much higher wet condition toughness (conditioned toughness or CON toughness) compared with that of a polyamide 6 homopolymer. The conditioned toughness may be determined according to ASTM D-256. At 23° C., the measured conditioned toughness may be as little as 180 J/m, 200 J/m, 250 J/m, as high as 450 J/m, 550 J/m, 650 J/m, or within any range defined by any two of the foregoing values, such as 180 J/m to 650 J/m, or 200 J/m to 550 J/m, for example. At −20° C., the measured conditioned toughness may be as little as 40 J/m, 50 J/m, 60 J/m, as high as 150 J/m, 200 J/m, 250 J/m, or within any range defined by any two of the foregoing values, such as 40 J/m to 250 J/m, or 60 J/m to 200 J/m, for example. At −40° C., the measured wet condition toughness may be as little as 30 J/m, 40 J/m, 50 J/m, as high as 100 J/m, 150 J/m, 200 J/m, or within any range defined by any two of the foregoing values, such as 30 J/m to 200 J/m, or 50 J/m to 150 J/m, for example.

In some exemplary embodiments, a finished part formed from the present polyamide 6/66 copolymer base resin composition has much higher dry condition (DAM) toughness compared with that of a polyamide 6 homopolymer. The dry condition toughness may be determined according to ASTM D-256. At 23° C., the measured dry condition toughness may be as little as 30 J/m, 40 J/m, 50 J/m, as high as 100 J/m, 150 J/m, 250 J/m, or within any range defined by any two of the foregoing values, such as 30 J/m to 250 J/m, or 40 J/m to 150 J/m, for example. At −20° C., the measured dry condition toughness may be as little as 30 J/m, 40 J/m, 50 J/m, as high as 90 J/m, 120 J/m, 180 J/m, or within any range defined by any two of the foregoing values, such as 30 J/m to 180 J/m, or 40 J/m to 120 J/m, for example. At −40° C., the measured dry condition toughness may be as little as 25 J/m, 30 J/m, 40 J/m, as high as 90 J/m, 120 J/m, 180 J/m, or within any range defined by any two of the foregoing values, such as 20 J/m to 180 J/m, or 40 J/m to 120 J/m, for example.

The present polyamide 6/66 copolymers have lower shrinkage than polyamide 6 homopolymers. The shrinkage may be determined according to ASTM D-955. In some exemplary embodiments, the measured initial shrinkage vertical to the flow direction (“Ws”) may be as little as 0.45%, 0.51%, 0.55%, as high as 0.80%, 0.90%, 1.2%, or within any range defined by any two of the foregoing values, such as 0.45% to 1.2%, or as 0.55% to 0.90%, for example. The measured 48 hours shrinkage vertical to the flow direction may be as little as 0.51%, 0.55%, 0.60%, as high as 0.90%, 1.0%, 1.3%, or within any range defined by any two of the foregoing values, such as 0.51% to 1.3%, or as 0.55% to 0.90%, for example. The measured initial shrinkage parallel to the flow direction (“Ls”) may be as little as 0.10%, 0.15%, 0.20%, as high as 0.80%, 0.90%, 1.0%, or within any range defined by any two of the foregoing values, such as 0.10% to 1.0%, or as 0.15% to 0.90%, for example. The measured 48 hours shrinkage parallel to the flow direction may be as little as 0.11%, 0.16%, 0.21%, as high as 0.80%, 1.0%, 1.1%, or within any range defined by any two of the foregoing values, such as 0.11% to 1.1%, or 0.16% to 1.0%, for example.

In some exemplary embodiments, a finished fiber reinforced part formed from the present polyamide 6/66 copolymer base resin composition has better surface finish, much lower floating fiber, and higher gloss compared with that of a polyamide 6 homopolymer. Surface finish and appearance may be determined by visual inspection. The gloss may be determined according to ASTM D-523. In some exemplary embodiments, the measured gloss at 60° angle of incidence may be as little as 50.0, 55.0, 60.0, as high as 85.0, 90.0, 95.0, or within any range defined by any two of the foregoing values, such as 55.0 to 90.0, or as 55.0 to 95.0, for example.

Finished articles made from polyamide 6/66 copolymer, both form the neat polymer and with a reinforcement component, also show better smooth surface finish than corresponding finished articles made from polyamide 6 homopolymer.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### EXAMPLES

Exemplary formulations were tested using differential scanning calorimetry to determine melt point temperature (Tₘ) and crystallization temperature (T_{c}) in accordance with ASTM D3418 and isothermal crystallization time (t_{1/2}) in accordance with ASTM E2070.

### Example 1

### Comparative Crystallization Rate Study

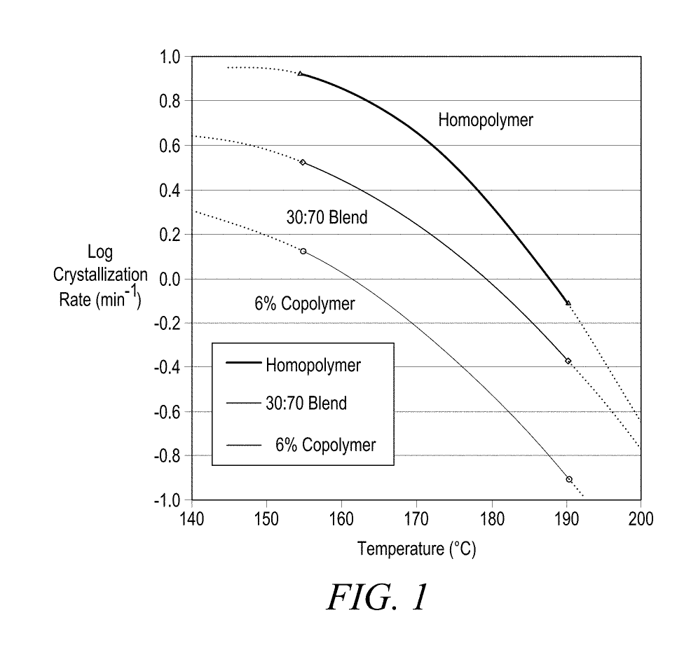

Referring to FIG. 1, the log crystallization rate of various compositions was determined as a function of temperature. Solid lines indicate experimental data, while dashed lines indicate extrapolated values for crystallization rate based on the Sestak Berggren equation. As shown in the upper curve of FIG. 1, the crystallization rate of PA 6 homopolymer is relatively high.

The middle curve of FIG. 1 shows the crystallization rate of a physical blend of 70 mol. % PA 6 homopolymer having a melting point of 220° C., relative viscosity 4.0 with 30 mol. % of a PA 6/66 copolymer having a melting point of 193° C. and relative viscosity of 4.0. The PA 6/66 copolymer contains about 82 mol. % PA 6 and 18 mol. % PA 66, and the 30:70 blend overall is estimated to contain about 5.4 mol. % of the PA 66 material. As shown in FIG. 1, the addition of the PA 66 reduces the crystallization rate of the blend compared to that of the PA 6 monomer.

The lower curve of FIG. 1 further shows the crystallization rate of a copolymer formed from a copolymerized mixture of 94 mol. % caprolactam and 6 mol. % AH salt. Although containing a similar amount of the AH salt monomers as the 30:70 blend, the 6 mol. % copolymer formed from the caprolactam and AH salt had a lower crystallization rate than the 30:70 blend of the middle curve. Without wishing to be held to any particular theory, it is believed that the more homogenous distribution of the AH salt monomers in the caprolactam monomers further lower the crystallization rate.

### Example 2

### Crystallization Rates of Polyamide 6/66 Copolymers

Polyamide compositions containing various amounts of caprolactam and AH salt were produced in pellet form. Pellets of each composition were produced with according to the molar percent of caprolactam and AH salt shown in Table 1 below. For each sample, the polyamide composition was produced in a continuous process from the caprolactam and AH salt monomers. The temperature for each stage was set to 260° C. with a flow rate of around 7000 lb/hr.

Thermal analysis was performed on a 6 mg sample of each composition by using a TA Q series differential scanning calorimeter (DSC) at a heating rate of 10° C./min to 265° C., followed by rapid cooling to 170° C. and holding for 30 minutes. The Tₘ, T_{c}, and t_{1/2} for each sample are provided in Table 1.

TABLE 1
Tₘ, T_{c}, and t_{1/2} of compositions
having varying levels of monomers

| | Mol. % | Mol. % | Tₘ | T_{c} | t_{1/2} |
|---|---|---|---|---|---|
| Ref. No. | Caprolactam | AH Salt | (° C.) | (° C.) | (min) |
| Ex 1A | 96 | 4 | 208.5 | 159.7 | 1.16 |
| Ex 1B | 94 | 6 | 203.3 | 156.8 | 2.14 |
| Ex 1C | 92 | 8 | 199 | 150.7 | 3.65 |
| Ex 1D | 90 | 10 | 198.4 | 151.3 | 3.66 |

As shown in Table 1, increasing the amount of AH salt monomers in the copolymer resulted in generally decreasing melt and crystallization temperatures.

### Example 3

### Crystallization Rates of Polyamide 6/66 Copolymer Films

Polyamide compositions containing various amounts of caprolactam and AH salt were produced in pellet form. Pellets of each composition were produced with according to the molar percent of caprolactam and AH salt shown in Table 2.

Cast films were prepared from pellets of each composition using a Haake single screw extruder (Zone temperature: 240˜260° C., roll temperature: 25° C., screw rpm: 75, melt temperature: 250° C.). In addition, comparative films were produced from a dry blended mixture of 70 wt. % PA6 and 30 wt. % PA 6/66 pellets. The PA 6 pellets were Ultramid® B40 polyamide and the PA 6/66 pellets were Ultramid® C40 L polyamide, each available from BASF. The comparative pellets were similar in PA 6 and PA 66 concentration to the 94/6 concentration of Ex. 2B.

Thermal analysis was performed on a 6 mg sample of each composition by using a TA Q series differential scanning calorimeter (DSC) at a heating rate of 10° C./min to 265° C., followed by rapid cooling to 170° C. and holding for 30 minutes. The Tₘ, T_{c}, and t_{1/2} for each sample are provided in Table 2.

TABLE 2
Tₘ, T_{c}, and t_{1/2} of films formed from compositions
having varying levels of monomers

| | Mol. % | Mol. % | Tₘ | T_{c} | t_{1/2} |
|---|---|---|---|---|---|
| Ref. No. | Caprolactam | AH Salt | (° C.) | (° C.) | (min) |
| Comp. | — | — | 209.9; | 181 | 0.28 |
| Ex. 2 | | | 217.9 | | |
| Ex. 2A | 96 | 4 | 210 | 167.4 | 1.06 |
| Ex. 2B | 94 | 6 | 206 | 162 | 1.43 |
| Ex. 2C | 92 | 8 | 201.7 | 156.2 | 3.75 |
| Ex. 2D | 90 | 10 | 203.3 | 161.7 | 1.98 |
| Ex. 2E | 85 | 15 | 190.1 | 144.8 | N/A |

As shown in Table 2, increasing the PA 66 nature of the composition by increasing the percentage of AH salt in the copolymer resulted in generally decreasing melt and crystallization temperatures and increasing isothermal crystallization time.

In addition, Examples 2A-2E, which were formed from the wholly compounded PA compositions, had a lower crystallization temperature (T_{c}) and longer isothermal crystallization time than the pellet blend of Comp. Ex. 2. Ex. 2B and Comp. Ex. 2 each contained about 94 mol. % caprolactam and 6 mol. % AH salt. However, the Ex. 2B sample provided a decrease of nearly 20° C. and a substantial increase in isothermal crystallization time compared to Comp. Ex. 2. Without wishing to be held to any particular theory, it is believed that forming the copolymer directly from the caprolactam and AH salt monomers provides for a more homogenous distribution of the AH salt monomers within the end composition compared to a blend of PA 6 and PA 6/66 compositions. This increased homogeneity is believed to provide the substantial improvements shown in Table 2, even at comparable monomer concentrations.

### Example 4

### Further Polyamide 6/66 Copolymer Studies

As shown in Table 3 below, various polyamide 6/66 copolymers were tested for their respective properties and compared to a blend of 70 wt. % PA 6 homopolymer with 30 wt. % of a PA 6/66 copolymer (Comparative Example 3). The copolymers were made using continuous melt polymerization in which a physical powder blend or melt blend of 70 wt. % of B40 PA 6 homopolymer and 30 wt. % of C40L PA6/66 copolymer are fed into a single screw extruder operating at a melt temperature of 250° C.

Thermal analysis was performed on the samples shown in Table 3 and conducted in the manner as described in Example 3.

TABLE 3
Tₘ, T_{c}, and moisture measurements of films formed
from compositions having varying levels of monomers

| | Mol. % | Mol. % | | Tₘ | T_{c} | Moisture |
|---|---|---|---|---|---|---|
| Ref. No. | Caprolactam | AH Salt | FAV | (° C.) | (° C.) | (ppm) |
| Comp. | — | — | 160 | 220.5 | 166.5 | — |
| Ex. 3 | | | | | | |
| Ex. 3A | 96 | 4 | 160 | 206.3 | 160.7 | 220 |
| Ex. 3B | 94 | 6 | 160 | 202.1 | 151.1 | 610 |
| Ex. 3C | 92 | 8 | 160 | 200.5 | 148.2 | 130 |
| Ex. 3D | 90 | 10 | 160 | 196.7 | 148.9 | 270 |

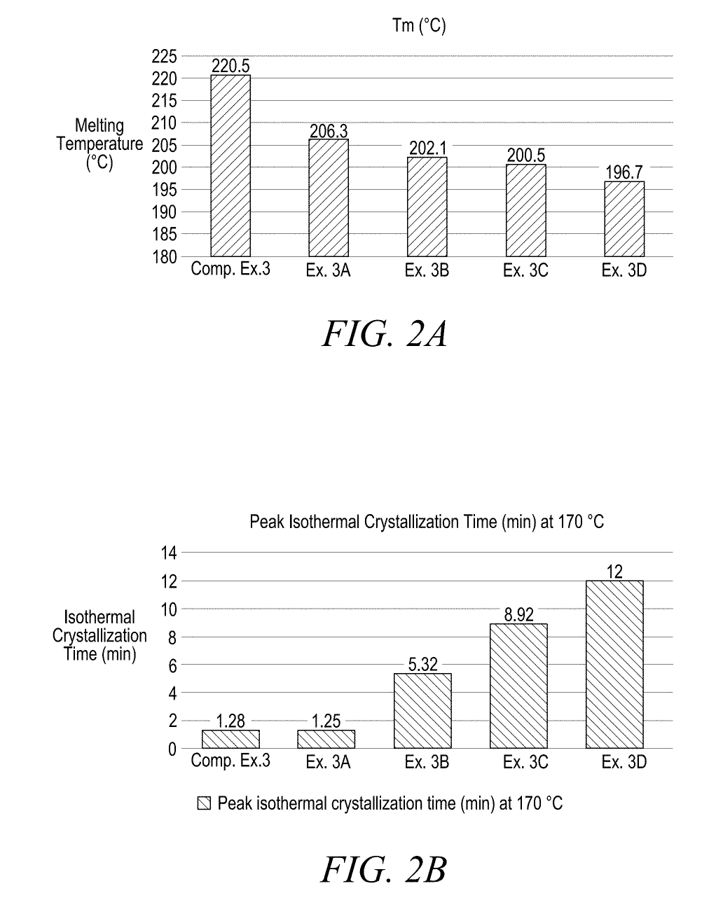

As shown in Table 3 and in FIGS. 2A and 2B, increasing the PA 66 nature of the composition by increasing the percentage of AH salt in the copolymer resulted in generally decreasing melt and crystallization temperatures and increasing isothermal crystallization time at 170° C. (FIG. 2B).

In addition, Examples 3A-3D, which were formed from the wholly compounded PA compositions, had a lower melt temperature (Tₘ) and crystallization temperature (T_{c}) than the pellet blend of Comp. Ex. 3 as shown in FIG. 2A and 2B. Ex. 3B and Comp. Ex. 3 each contained about 94 mol. % caprolactam and 6 mol. % AH salt. However, the Ex. 3B sample provided a decrease of nearly 20° C. (FIG. 2A) and a substantial increase in isothermal crystallization time (FIG. 2B) compared to Comp. Ex. 3.

Without wishing to be held to any particular theory, it is believed that forming the copolymer directly from the caprolactam and AH salt monomers provides for a more homogenous distribution of the AH salt monomers within the end composition compared to a blend of PA 6 and PA 6/66 compositions. This increased homogeneity is believed to provide the substantial improvements shown in Table 3, even at comparable monomer concentrations.

Polyamide compositions containing various amounts of caprolactam and AH salt were produced in pellet form. Samples for nuclear magnetic resonance (NMR) spectroscopy were prepared in 5 mm NMR tubes. Each sample weighed approximately 25 mg and was dissolved in 1 mL deuterated H₂SO₄ to get a clear solution. The solution was locked externally with either a 0.2 mL solution of CDCl₃ or a 0.2 mL solution of CD₃COCD₃ and spectra were recorded on a 100 MHz (¹³C) NMR instrument. The ¹³C Quantitative NMR spectra were acquired using a program (e.g., Bruker pulse program).

¹³C NMR spectroscopy was utilized to determine the distribution of polyamide 6 and polyamide 6,6 structural units in the polyamide 6/66 copolymers. A sample of each formulation was dissolved in deuterated sulfuric acid solution (96-98 wt. % in D₂O) at a concentration of approx. 2.5 wt. %, and chemical shifts were measured with respect to an external locking agent of either CDCl₃ or CD₃COCD₃.

Quantitative ¹³C spectra were acquired on a Bruker AV-III 400 MHz NMR Spectrometer operating at 100.62 MHz, the spectral width was 24 kHz, the relaxation delay was 5 seconds, and inverse gated decoupling was used to eliminate the nuclear Overhauser effect. A total of 8000 scans were acquired.

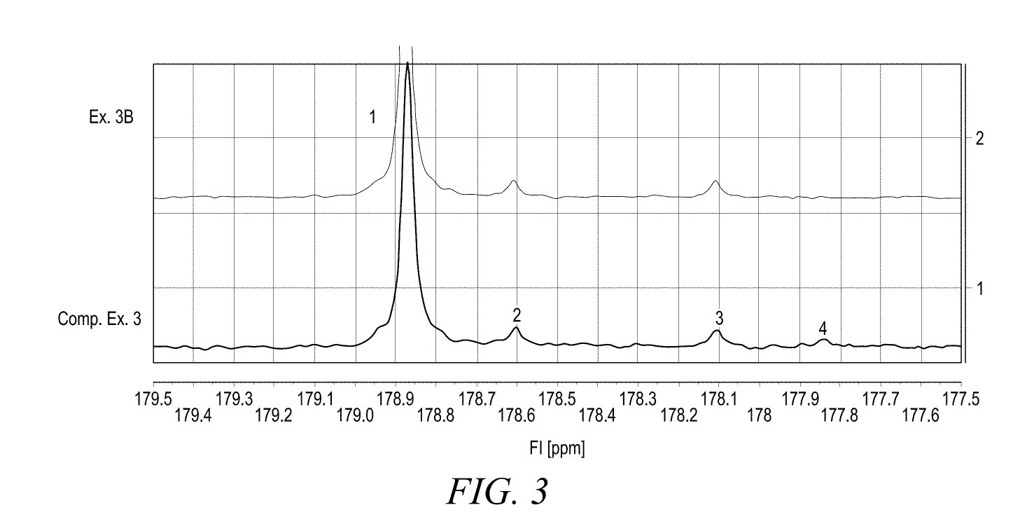

The composition, the sequence distributions, and the degree of randomness were calculated (with Formulas I and II as shown below) from the intensities of carbonyl peaks in the spectra as shown in FIG. 3.

$$\begin{matrix}Polyamide 6.6 mol \% = \frac{{I}_{PA 6.6 - PA 6} + {I}_{PA 6.6 - PA 6.6}}{{I}_{total}} \times 100 \% & ( I ) \\ Degree of randomness ( R ) = \frac{{I}_{PA 6 - PA 6.6}}{{I}_{PA 6 - PA 6} + {I}_{PA 6 - PA 6.6}} + \frac{2 {I}_{PA 6.6 - PA 6}}{{I}_{PA 6.6 - PA 6} + {I}_{PA 6.6 - PA 6.6}} & ( II )\end{matrix}$$

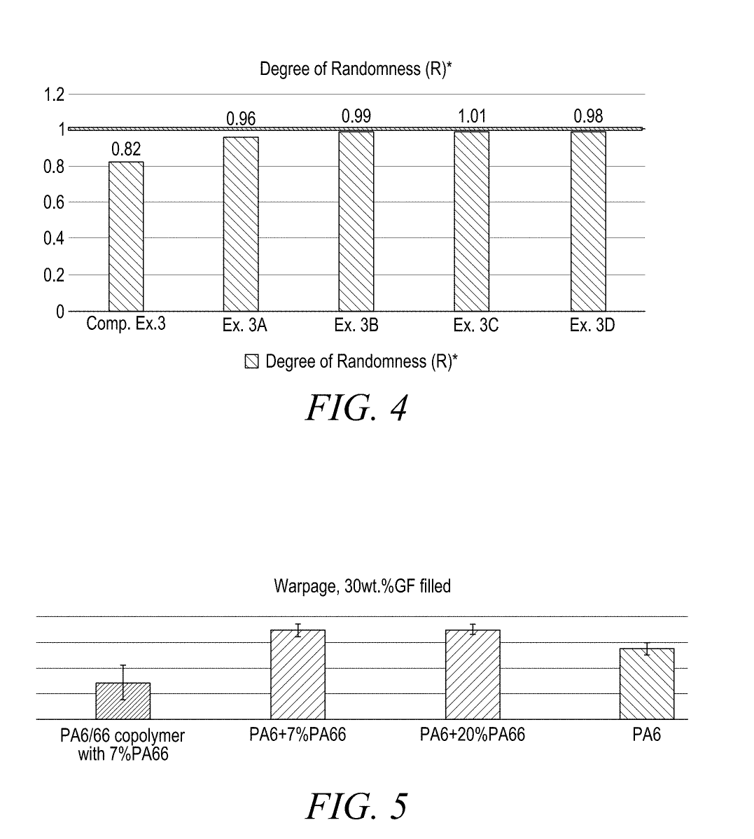

As shown in FIG. 3, Comp. Ex. 3 has an additional peak at point 4 indicating the presence of additional polyamide 6,6,-polyamide 6,6 block. Furthermore, as shown in FIG. 4 and in Table 4 below, as compared to Comp. Ex. 3, the degree of randomness clearly increases with Examples 3A-3D, though there may be some slight inaccuracies in these measured results. As such, Ex. 3A-3D yield more random copolymers than melt blending in a single screw extruder. Also, Ex. 3A and 3B have lower nylon 6,6 content and polyamide 6-polyamide 66 and polyamide 66-polyamide 6 bonding as compared to Comp. Ex. 3.

TABLE 4
Compositions of films formed from compositions having varying levels of monomers

| | | CPL-CPL | CPL-HMDA | ADA-CPL | ADA-HDMA | |
|---|---|---|---|---|---|---|
| | Polyamide | Bond | Bond | Bond | Bond | |
| | 66 Content | (mol. %) | (mol. %) | (mol. %) | (mol. %) | Degree of |
| Sample | (wt. %) | PA6-PA6 | PA6-PA66 | PA66-PA6 | PA66-PA66 | Randomness |
| Comp. | 10.5 | 81.2 | 8.2 | 7.7 | 2.9 | 0.8 |
| Ex. 3 | | | | | | |
| Ex. 3A | 6.4 | 87.3 | 6.3 | 5.7 | 0.7 | 1.0 |
| Ex. 3B | 7.9 | 84.4 | 7.7 | 7.2 | 0.7 | 1.0 |
| Ex. 3C | 9.4 | 80.9 | 9.7 | 8.5 | 0.9 | 1.0 |
| Ex. 3D | 11.7 | 77.7 | 10.6 | 10.1 | 1.6 | 1.0 |

### Example 5

### Warpage Study

Formulation information of polyamides is provided below in Table 5. Sample “PA6/66 copolymer with 7% PA66” means the synthesized polyamide 6/66 copolymer with 7% polyamide 6. “PA6+7%PA66” means physical melt blending of 93% polyamide 6 and 7% polyamide 66 via compounding. “PA6+20%PA66” means physical melt blending of 80% polyamide 6 and 20% polyamide 66 via compounding. PA6 means polyamide 6 homopolymer. These samples also include 30 wt. % glass fiber reinforcement for warpage testing.

TABLE 5
Formulation for warpage testing

| | Formulation | | | |
|---|---|---|---|---|
| | PA6/66 copolymer | PA6 + | PA6 + | |
| Raw materials | with 7% PA66 | 7% PA66 | 20% PA66 | PA6 |
| polyamide 6 | 0 | 65.1% | 56% | 70% |
| polyamide6/66 | 70% | 0 | 0 | 0 |
| copolymer with | | | | |
| 7 mol. % PA66 | | | | |
| polyamide 66 | 0 | 4.9% | 14% | 0 |
| Glass fiber | 30 wt. % | 30 wt. % | 30 wt. % | 30 wt. % |

As shown in FIG. 5, 30 wt. % glass fiber filled PA 6/66 copolymer with 7% PA66 shows significantly lower warpage than 30 wt. % glass fiber filled PA6, 30 wt. % glass fiber filled PA6+7%PA66 and 30 wt. % glass fiber filled PA6 +20%PA66. 30 wt % glass fiber filled PA6+7%PA66 and 30 wt. % glass fiber filled PA6+20%PA66 show highest warpage among the tested samples, which is believed to result from the lower crystalline degree and lower shrinkage of the PA6/66 copolymer with 7% PA66 than the PA6 and PA6+7%PA66 and PA6+20%PA66 formulations.

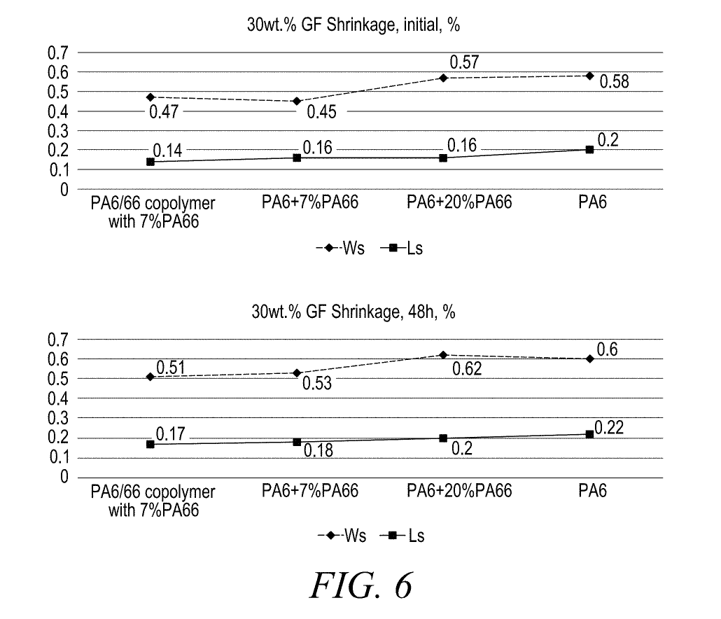

Shrinkage is given in FIG. 6. “Ws” means shrinkage vertical to the flow direction, and “Ls” means shrinkage parallel to the flow direction. 30 wt. % glass fiber filled PA6/66 copolymer with 7% PA66 shows lowest shrinkage among the tested samples. Lower shrinkage will facilitate lower warpage. However, the 30 wt. % glass fiber filled PA6+7%PA66 blend has similar shrinkage as the claimed PA6/66 copolymer with 7%PA66, while much higher warpage. Warpage will be influenced by crystallization time, crystal size, shrinkage and processing, wherein samples having similar shrinkage may have different warpage behavior.

Crystalline degree, or crystallization, is given in Table 6 using the following equation to calculate the crystalline degree:

$$Crystalline degree = \frac{Crystalline enthalpy}{Standard enthalpy}$$

Crystalline enthalpy is acquired by dynamic differential scanning calorimeter (DSC). The dynamic DSC analysis was performed on a 6 mg sample of each composition at a heating rate of 10° C./min to 280° C., followed by 10° C./min cooling from 280° C. to 25° C. and then heating to 280° C. at a heating rate of 10° C./min. Crystalline enthalpy is the heat released during the cooling process. Standard enthalpy of PA6 is 230J/g, very similar with PA66 (226J/g). To make this calculation easier, 228J/g was used as a standard enthalpy for crystalline degree calculation for PA6/66 copolymer with 7% PA66, PA6+7%PA66 and PA6+20%PA66. Test results show that PA6/66 copolymer with 7% PA66 has lowest crystalline degree among the tested samples, which may explain the lowest warpage of PA6/66 copolymer with 7% PA66 among the tested samples.

TABLE 6
Crystalline degree calculated by dynamic
differential scanning calorimeter

| | PA6/66 copolymer | PA6 + | PA6 + | |
|---|---|---|---|---|
| | with 7% PA66 | 7% PA66 | 20% PA66 | PA6 |
| Neat resin | 19.17 | 20.70 | 22.98 | 23.90 |
| 30 wt % glass | 20.36 | 22.13 | 23.93 | 26.13 |
| filled | | | | |

### Example 6

### Dry Condition Toughness of Polyamide 6/66 Copolymers

Toughness of the following formulations was tested: polyamide 6/66 copolymer with 7% PA66 and polyamide 6 neat resin, 15 wt. % glass fiber filled polyamide 6/66 copolymer with 7% PA66 and 15 wt. % glass fiber filled polyamide 6, 30 wt. % glass fiber filled polyamide 6/66 copolymer with 7% PA66 and 30 wt. % glass fiber filled polyamide 6. Notched izod impact strength was used to characterize toughness. The notched izod impact strength is provided in Table 7. PA6/66 copolymer with 7% PA66 neat resin shows similar notched izod impact strength with PA6 neat resin at 23, −20 and −40° C. 15 wt % glass fiber filled PA6/66 copolymer with 7% PA66 also shows similar notched izod impact strength with 15% glass fiber filled PA6 at 23, −20 and −40° C. 30 wt % glass fiber filled PA6/66 copolymer with 7% PA66 shows 19.2% higher notched izod impact strength than 30 wt. % glass fiber filled PA6 at 23° C., 10% higher at −20 and −40° C. As polyamide 6 and polyamide 6/66 copolymer are seldom used in a form of neat resin, a 30 wt. % filled formulation may be considered as a generally used formulation. Thus, polyamide 6/66 has an advantage in dry condition toughness compared with polyamide 6.

TABLE 7
Notched izod impact strength of PA6 and PA6/66
copolymer with 7% PA66, dry condition

| | | | | PA6/66 copolymer |
|---|---|---|---|---|
| Performance, dry condition | | | PA6 | with 7% PA66 |
| Notched Izod | Neat resin | 23° C. | 29.3 | 30.6 |
| Impact | | −20° C. | 30.9 | 35.1 |
| Strength, J/m | | −40° C. | 32.4 | 31.6 |
| | 15 wt % glass | 23° C. | 60.9 | 62.7 |
| | fiber filled | −20° C. | 49.9 | 52.5 |
| | | −40° C. | 51.4 | 52.6 |
| | 30 wt % glass | 23° C. | 123.8 | 147.6 |
| | fiber filled | −20° C. | 92.0 | 102.1 |
| | | −40° C. | 93.3 | 100.3 |

### Example 7

### Conditioned Toughness of the Polyamide 6/66 Copolymers

Table 8 gives the formulation for conditioned notched izod impact strength study. In table 8, the sample “PA6/66 copolymer with 7% PA66”, “PA6”, “PA6+7%PA66” and “PA6+20%PA66” have the same composition as that provided in Table 5. “PA66” means polyamide 66 homopolymer. Compositions of the base resin at 0 wt., 15 wt. % and 30 wt. % glass fiber filled are used for conditioned toughness testing.

TABLE 8
Formulation for conditioned toughness testing

| | Formulation | | | | |
|---|---|---|---|---|---|
| | PA6/66 | PA6 + | PA6 + | | |
| Raw | copolymer with | 7 wt % | 20 wt % | | |
| materials | 7% PA66 | PA66 | PA66 | PA6 | PA66 |
| polyamide 6 | 0 | 65.1 wt. % | 56 wt. % | 70 wt. % | 0 |
| polyamide 6/66 | 70 wt % | 0 | 0 | 0 | 0 |
| copolymer with | | | | | |
| 7% PA66 | | | | | |
| polyamide66 | 0 | 4.9 wt. % | 14 wt. % | 0 | 70 wt. % |
| Glass fiber | 0, 15 wt. | 0, 15 wt. | 0, 15 wt. | 0, 15 wt. | 0, 15 wt. |
| | %, 30 wt. % | %, 30 wt. % | %, 30 wt. % | %, 30 wt. % | %, 30 wt. % |

Conditioned notched izod impact strength is given in Table 9. PA6/66 copolymer with 7% PA66 neat resin shows significantly higher notched izod impact strength than the other tested neat resin at 23° C. 15 wt. % and 30 wt. % glass fiber filled PA6/66 copolymer with 7% PA66 also shows obviously higher notched izod impact strength than the other tested 15 wt. % and 30 wt. % glass fiber filled formulation at 23° C. This should be mainly caused by the lower crystalline degree of PA6/66 copolymer with 7% PA66 than the other tested formulations. PA66 has the lowest notched izod impact strength compared with the other samples. This may be due to the different water content in PA66 and/or different water absorption rate.

Notched izod impact strength of PA6/66 copolymer with 7%PA66 neat resin is similar with PA6 neat resin and lower than PA66, PA6+7%PA66 and PA6+20%PA66 neat resin, at −20° C. and −40° C. Notched izod impact strength of 15 wt. % glass fiber filled PA6/66 copolymer with 7%PA66 is similar with the other tested 15 wt. % glass fiber filled formulation, at −20° C. and −40° C. Notched izod impact strength of 30 wt. % glass fiber filled PA6/66 copolymer with 7%PA66 is similar to 30 wt. % glass fiber filled PA6+7%PA66 and PA6+20%PA66 and higher than 30 wt. % glass fiber filled PA6 and PA66, at −20° C. and −40° C.

TABLE 9
Conditioned notched izod impact strength

| | | | | PA6/66 | | | |
|---|---|---|---|---|---|---|---|
| | | | | copolymer | PA6 + | PA6 + | |
| | | Temperature | PA6 | with 7% PA66 | 7% PA66 | 20% PA66 | PA66 |
| Notched | Neat | 23° C. | 284.6 | 466.2 | 201.9 | 268.3 | 65.1 |
| Izod | resin | −20° C. | 43.4 | 41.4 | 59.0 | 63.1 | 61.3 |
| Impact, | | −40° C. | 27.6 | 30.4 | 60.6 | 60.1 | 52.7 |
| J/m | 15 wt. % | 23° C. | 109.9 | 183.6 | 135.6 | 123.9 | 68.4 |
| | glass | −20° C. | 50.0 | 54.3 | 56.0 | 60.7 | 52.1 |
| | fiber | −40° C. | 50.3 | 51.6 | 52.6 | 53.0 | 54.8 |
| | filled | | | | | | |
| | 30 wt. % | 23° C. | 200.5 | 256.7 | 216.5 | 228.2 | 133.2 |
| | glass | −20° C. | 102.3 | 113.0 | 112.9 | 113.6 | 91.2 |
| | fiber | −40° C. | 91.5 | 100.7 | 102.0 | 101.2 | 84.2 |
| | filled | | | | | | |

### Example 8

### Mechanical Strength

For the mechanical strength study, the same formulations as in Table 8 were used.

Table 10A and 10B give the mechanical strength of neat resin and 30 wt. % glass fiber filled PA6, PA66, PA6/66 copolymer with 7% PA66, PA6+7%PA66 and PA6+20%PA66 at dry condition. PA6/66 copolymer with 7%PA66 shows lower mechanical strength than PA6, PA66, PA6+7%PA66 and PA6+20%PA66 at dry condition. 30 wt. % glass fiber filled PA6/66 copolymer with 7% PA66 also shows lower mechanical strength than the 30 wt. % glass fiber filled PA6, PA66, PA6+7%PA66 and PA6+20%PA66 at dry condition, but the gap is smaller than the neat resin data. Relatively high crystalline degree of PA6 and PA66 contributes to the high mechanical strength, once filling glass fiber, the influence of crystalline degree on mechanical strength will be weakened, so the gap is smaller when filling 30 wt. % glass fiber compared with neat resin.

TABLE 10A
Mechanical performance of unreinforced resin at dry condition

| | | Un-reinforced resin, dry condition | | | |
|---|---|---|---|---|---|
| | | | PA6/66 | | |
| | | | copolymer | | |
| | | | with 7% | PA6 + | PA6 + |
| Mechanical performance | | PA6 | PA66 | 7% PA66 | 20% PA66 |
| Tensile | Modulus | 2203.46 | 2075.07 | 2288.84 | 2216.07 |
| Properties, | Strength | 78.47 | 68.48 | 73.79 | 71.45 |
| MPa | | | | | |
| Tensile | @ Break | 28.55 | 41.11 | 46.04 | 36.58 |
| elongation, % | | | | | |
| Flexural | Modulus | 3098.42 | 2481.35 | 2818.83 | 2811.41 |
| Properties, | Strength | 124.77 | 100.94 | 116.95 | 117.17 |
| MPa | | | | | |

TABLE 10B
Mechanical performance of 30 wt. % glass fiber filled 6/66 formulation at dry condition

| | | 30 wt. % glass fiber Filled, dry condition | | | | |
|---|---|---|---|---|---|---|
| | | | PA6/66 | | | |
| | | | copolymer | PA6 + | PA6 + | |
| Mechanical performance | | PA6 | with 7% PA66 | 7% PA66 | 20% PA66 | PA66 |
| Tensile Properties, | Modulus | 5694.2 | 5539.0 | 5793.2 | 4305.6 | 5928.4 |
| MPa | Strength | 167.2 | 156.7 | 172.8 | 173.8 | 179.2 |
| Tensile elongation, % | @ Break | 5.0 | 5.5 | 5.4 | 5.4 | 5.4 |
| Flexural Properties, | Modulus | 8217.9 | 7791.2 | 8381.7 | 8152.5 | 8048.3 |
| MPa | Strength | 240.2 | 237.7 | 255.8 | 247.2 | 274.3 |

Tables 11A and 11B provide the conditioned mechanical strength of unreinforced resin and 30 wt. % glass fiber filled PA6, PA66, PA6/66 copolymer with 7% PA66, PA6+7%PA66 and PA6+20%PA66. PA6/66 copolymer with 7% PA66 resin shows lower conditioned mechanical strength than PA6, PA66, PA6+7%PA66 and PA6+20%PA66, PA66 neat resin shows the best conditioned mechanical strength. 30 wt. % glass fiber filled PA6/66 copolymer with 7% PA66 also has lower mechanical strength than the 30 wt. % glass fiber PA6, PA66, PA6+7%PA66 and PA6+20%PA66 at dry condition, but the gap is smaller than the neat resin data. Relatively low crystalline degree of PA6/66 copolymer with 7%PA66 leads to the low mechanical strength. Once filled with glass fiber, the influence of crystalline degree on mechanical strength will be weakened, so the gap is smaller for the 30 wt. % glass fiber filled formulation compared with neat resin.

TABLE 11A
Conditioned mechanical performance of unreinforced resin

| | | Unreinforced resin, conditioned | | | | |
|---|---|---|---|---|---|---|
| | | | PA6/66 | | | |
| | | | copolymer | PA6 + | PA6 + | |
| Mechanical performance | | PA6 | with 7% PA66 | 7% PA66 | 20% PA66 | PA66 |
| Tensile Properties, | Modulus | 1060.8 | 573.4 | 881.5 | 899.0 | 1608.4 |
| MPa | Strength | 44.2 | 33.2 | 42.2 | 42.4 | 65.7 |
| Tensile elongation, % | @ Break | 345.4 | 219.8 | 322.9 | 221.5 | 218.1 |
| Flexural Properties, | Modulus | 821.3 | 536.6 | 681.5 | 641.4 | 1189.3 |
| MPa | Strength | 39.3 | 30.1 | 34.9 | 32.8 | 54.4 |

TABLE 11B
Conditioned mechanical performance of 30 wt. % glass fiber filled 6/66 formulations

| | | 30 wt. % glass fiber filled, conditioned | | | | |
|---|---|---|---|---|---|---|
| | | | PA6/66 | | | |
| | | | copolymer | PA6 + | PA6 + | |
| Mechanical performance | | PA6 | with 7% PA66 | 7% PA66 | 20% PA66 | PA66 |
| Tensile Properties, | Modulus | 4295.2 | 3437.9 | 4026.2 | 4023.2 | 4959.6 |
| MPa | Strength | 111.1 | 97.5 | 109.2 | 110.2 | 131.5 |
| Tensile elongation, % | @ Break | 7.1 | 9.9 | 8.6 | 8.4 | 6.4 |
| Flexural Properties, | Modulus | 4339.9 | 3885.7 | 4397.3 | 4203.6 | 5500.7 |
| MPa | Strength | 152.5 | 138.7 | 164.4 | 157.7 | 203.3 |

### Example 9

### Shrinkage Study

For the shrinkage study, the same formulations were used as in Table 8.

Tables 12A, 12B, 12C give the initial, 24 hours, and 48 hours shrinkage of unreinforced resin, 15 wt. % and 30 wt. % glass fiber filled PA6, PA66, PA6/66 copolymer with 7% PA66, PA6+7%PA66 and PA6+20%PA66. Unreinforced PA6/66 copolymer with 7% PA66 resin shows lower shrinkage compared with the unreinforced PA66 and PA6+20%PA66 resin, similar shrinkage with the unreinforced PA6 and PA6+20%PA66 resin. 15 wt. % glass fiber filled PA6/66 copolymer with 7% PA66 shows the lowest shrinkage among the tested samples. The shrinkage advantage of PA6/66 copolymer with 7% PA66 over PA6, PA6+7%PA66, PA6+20%PA66 and PA66 in 30 wt. % glass fiber filled formulations is even more pronounced than that in 15 wt. % glass fiber filled formulations, mainly attributable to the lowest crystalline degree. PA66 shows the highest shrinkage among the tested samples.

TABLE 12A
Shrinkage of the unreinforced resin

| | | Unreinforced resin | | | | |
|---|---|---|---|---|---|---|
| | | | PA6/66 | | | |
| | | | copolymer | PA6 + | PA6 + | |
| Shrinkage | | PA6 | with 7% PA66 | 7% PA66 | 20% PA66 | PA66 |
| initial, % | Ws | 1.08 | 1.03 | 0.99 | 1.12 | 1.64 |
| | Ls | 0.98 | 0.94 | 0.95 | 1.09 | 1.61 |
| 24 h, % | Ws | 1.08 | 1.06 | 1.04 | 1.15 | 1.58 |
| | Ls | 0.99 | 1 | 0.99 | 1.1 | 1.48 |
| 48 h, % | Ws | 1.1 | 1.09 | 1.05 | 1.17 | 1.65 |
| | Ls | 1 | 1.07 | 1 | 1.11 | 1.55 |

TABLE 12B
Shrinkage of the 15 wt. % glass fiber filled formulations

| | | 15 wt. % GF Filled | | | | |
|---|---|---|---|---|---|---|
| | | | PA6/66 | | | |
| | | | copolymer | PA6 + | PA6 + | |
| Shrinkage | | PA6 | with 7% PA66 | 7% PA66 | 20% PA66 | PA66 |
| initial, % | Ws | 0.6 | 0.49 | 0.45 | 0.61 | 1.09 |
| | Ls | 0.29 | 0.26 | 0.27 | 0.31 | 0.58 |
| 24 h, % | Ws | 0.62 | 0.51 | 0.5 | 0.64 | 1.06 |
| | Ls | 0.31 | 0.27 | 0.28 | 0.31 | 0.56 |
| 48 h, % | Ws | 0.64 | 0.51 | 0.51 | 0.65 | 1.12 |
| | Ls | 0.32 | 0.27 | 0.28 | 0.32 | 0.56 |

TABLE 12C
Shrinkage of the 30 wt. % glass fiber filled formulations

| | | 30 wt. % glass fiber filled | | | | |
|---|---|---|---|---|---|---|
| | | | PA6/66 | | | |
| | | | copolymer | PA6 + | PA6 + | |
| Shrinkage | | PA6 | with 7% PA66 | 7% PA66 | 20% PA66 | PA66 |
| initial, % | Ws | 0.58 | 0.47 | 0.45 | 0.57 | 1.03 |
| | Ls | 0.2 | 0.14 | 0.16 | 0.16 | 0.36 |
| 24 h, % | Ws | 0.6 | 0.49 | 0.51 | 0.62 | 0.98 |
| | Ls | 0.21 | 0.16 | 0.18 | 0.19 | 0.34 |
| 48 h, % | Ws | 0.6 | 0.51 | 0.53 | 0.62 | 1 |
| | Ls | 0.22 | 0.17 | 0.18 | 0.2 | 0.35 |

### Example 10

### Surface Finish & Gloss Study

For surface finish and gloss study, the formulations are given in Table 13 below.

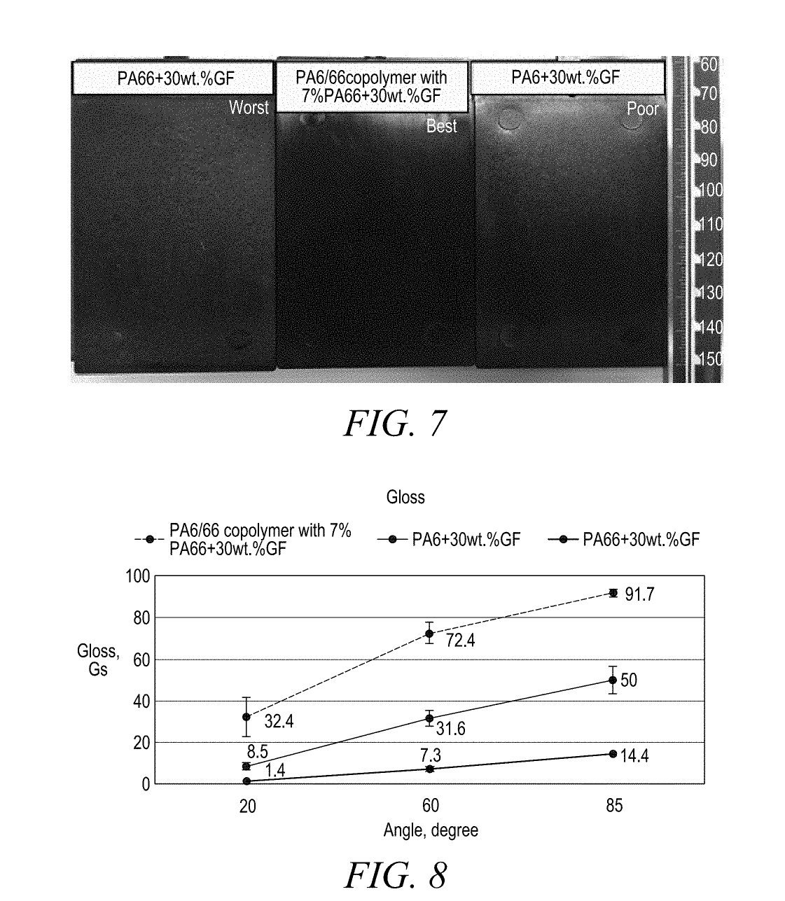

The appearance of the three samples is shown in FIG. 7. 30 wt. % glass fiber filled PA6/66 copolymer with 7%PA66 shows much better surface compared with 30 wt. % glass fiber filled PA6 and PA66. There was observed much less floating fiber in surface of 30 wt. % glass fiber filled PA6/66 copolymer with 7%PA66 compared with 30 wt. % glass fiber filled PA6 and PA66.

Gloss of the three samples is shown in FIG. 8. 30 wt. % glass fiber filled PA6/66 copolymer with 7%PA66 shows much higher gloss compared with 30 wt. % glass fiber filled PA6 and PA66. The good surface finish and high gloss of 30 wt. % glass fiber filled PA6/66 copolymer with 7%PA66 is mainly attributable to the lower crystallinity degree, lower crystallization rate and higher flowability of PA6/66 copolymer with 7%PA66 compared with PA6 & PA66.

TABLE 13
Formulations for surface finish & gloss study

| | Formulation | | |
|---|---|---|---|
| | PA6/66 copolymer | | |
| Raw materials | with 7% PA66 | PA6 | PA66 |
| polyamide 6 | 0 | 70 wt. % | 0 |
| polyamide 6/66 copol- | 70 wt. % | 0 | 0 |
| ymer with 7% PA66 | | | |
| polyamide66 | 0 | 0 | 70 wt. % |
| Glass fiber | 0, 15 wt. | 0, 15 wt. | 0, 15 wt. |
| | %, 30 wt. % | %, 30 wt. % | %, 30 wt. % |
| Carbon black master | 0.7 wt. % | 0.7 wt. % | 0.7 wt. % |
| batch | | | |

### Example 11

### Influence of PA66 Content on Toughness of PA6/66 Copolymer

In this example, the influence of PA66 content of PA66/66 copolymer on toughness was investigated, and the formulations are given below in Table 14. PA6/66 copolymer-1 to PA6/66 copolymer-6 have different PA66 content, and detailed PA66 content information is given in Table 15.

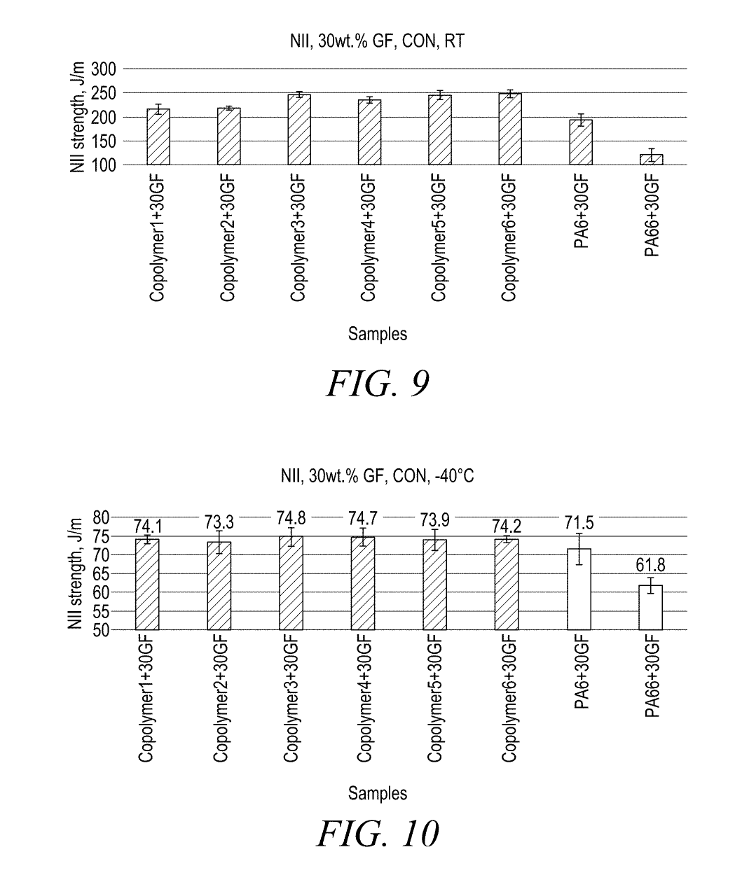

The Notched Izod Impact (NII) strength of 30 wt. % glass fiber filled PA6/66 copolymer with 6 different PA66 contents is shown in FIG. 9. 30 wt. % glass fiber filled PA6 & 30 wt. % glass fiber filled PA66 are used for comparison. The tested is conducted at Room Temperature (RT). Generally, in the studied PA66 content range, higher PA66 content gave a higher NII strength. 30 wt. % glass fiber filled copolymer shows higher NII strength compared with 30 wt. % glass fiber filled PA6 & PA66.

The Notched Izod Impact (NII) strength of 30 wt. % glass fiber filled PA6/66 copolymer is shown in FIG. 10. 30 wt. % glass fiber filled PA6 and 30 wt. % glass fiber filled PA66 are used for comparison. The tested is conducted at −40° C. Similar NII strength was found for different PA66 content copolymers in the studied PA66 content range at −40° C. 30 wt. % glass fiber filled copolymer shows higher NII strength compared with 30 wt. % glass fiber filled PA6 & PA66 at −40° C.

TABLE 14
Formulation for PA66 content influence on toughness study

| | Copolymer1 + | Copolymer2 + | Copolymer3 + | Copolymer4 + | Copolymer5 + | Copolymer6 + | PA6 + 30% | PA66 + 30% |
|---|---|---|---|---|---|---|---|---|
| | 30 GF | 30 GF | 30 GF | 30 GF | 30 GF | 30 GF | GF | GF |
| PA6/66 | | | | 0 | 0 | 0 | 0 | 0 |
| copolymer-1 | 70 wt. % | 0 | 0 | | | | | |
| PA6/66 | | | | 0 | 0 | 0 | 0 | 0 |
| copolymer-2 | 0 | 70 wt. % | 0 | | | | | |
| PA6/66 | | | | 0 | 0 | 0 | 0 | 0 |
| copolymer-3 | 0 | 0 | 70 wt. % | | | | | |
| PA6/66 | | | | 70 wt. % | 0 | 0 | 0 | 0 |
| copolymer-4 | 0 | 0 | 0 | | | | | |
| PA6/66 | | | | 0 | 70 wt. % | 0 | 0 | 0 |
| copolymer-5 | 0 | 0 | 0 | | | | | |
| PA6/66 | | | | 0 | 0 | 70 wt. % | 0 | 0 |
| copolymer-6 | 0 | 0 | 0 | | | | | |
| PA6 | 0 | 0 | 0 | 0 | 0 | 0 | 70 wt. % | 0 |
| PA66 | 0 | 0 | 0 | 0 | 0 | 0 | | 70 wt. % |
| Glass fiber | 30 wt. % | 30 wt. % | 30 wt. % | 30 wt. % | 30 wt. % | 30 wt. % | 30 wt. % | 30 wt. % |
| Carbon | 0.7 wt. % | 0.7 wt. % | 0.7 wt. % | 0.7 wt. % | 0.7 wt. % | 0.7 wt. % | 0.7 wt. % | 0.7 wt. % |
| black master | | | | | | | | |
| batch | | | | | | | | |

TABLE 15
PA66 content in different PA6/66 copolymer

| | Formulation |
|---|---|
| Raw materials | PA66 content, % |
| PA6/66 copolymer-1 | 1.9 |
| PA6/66 copolymer-2 | 3.9 |
| PA6/66 copolymer-3 | 5.3 |
| PA6/66 copolymer-4 | 7.4 |
| PA6/66 copolymer-5 | 10.6 |
| PA6/66 copolymer-6 | 14.3 |

### Example 12

### Influence of PA66 Content on Gloss of PA6/66 Copolymer

In this example, the influence of PA66 content of PA66/66 copolymer on gloss ws investigated, with the formulations given above in Table 14.

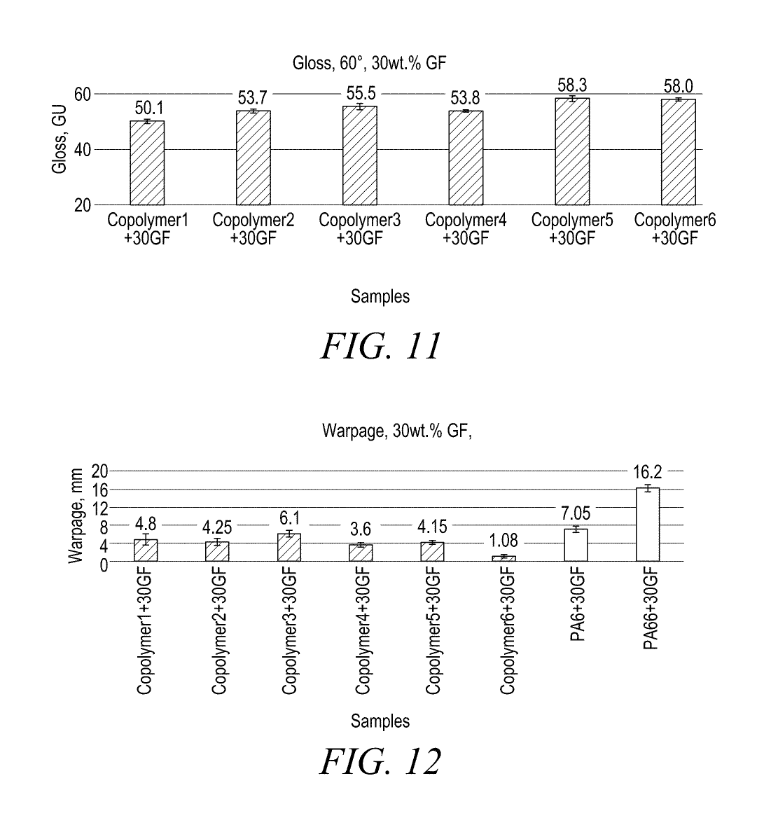

Measured gloss of 30 wt. % glass fiber filled PA6/66 copolymer with 6 different PA66 contents is shown in FIG. 11. Incidence angle is 60° C. Generally, higher PA66 content provides slightly higher gloss in the studied PA66 content range.

### Example 13

### Influence of PA66 Content on Warpage of PA6/66 Copolymer

In this example, the influence of PA66 content on warpage of PA6/66 copolymer was investigated, with the formulations given above in Table 14.

Warpage of 30 wt. % glass fiber filled PA6/66 copolymer with 6 different PA66 content is shown in FIG. 12. 30 wt. % glass fiber filled PA6 and 30 wt. % glass fiber filled PA66 are used for comparison. The warpage test method is set forth hereinabove. For the 30 wt. % glass fiber filled PA6/66 copolymer, higher PA66 content shows lower warpage generally, the 14.3% PA66 content copolymer shows obviously lower warpage than the other samples. The 30 wt. % glass fiber filled copolymer shows lower warpage compared with 30 wt. % glass fiber filled PA6 and 30 wt. % glass fiber filled PA66.

### Example 14

### Influence of PA66 Content on Shrinkage of PA6/66 Copolymer

In this example the influence of PA66 content on shrinkage of PA6/66 copolymer was investigated, with the formulations given above in Table 14.

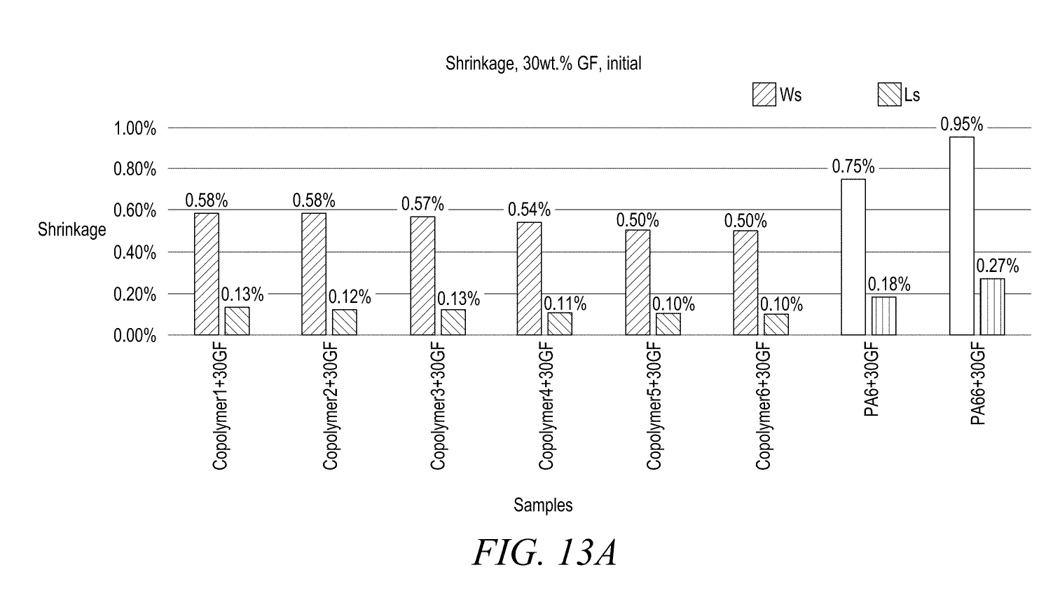

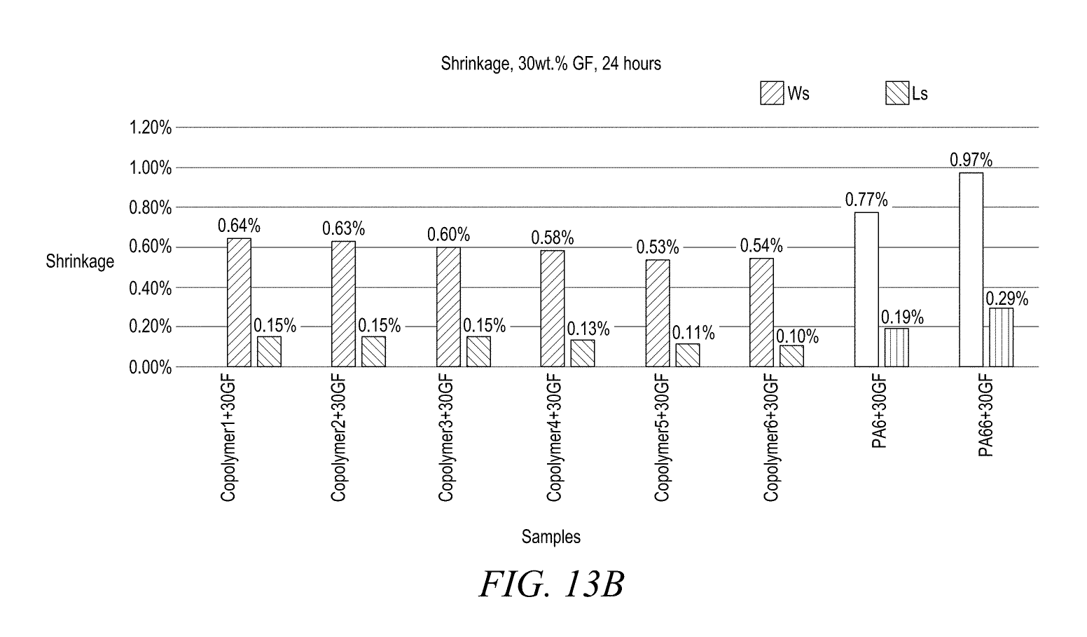

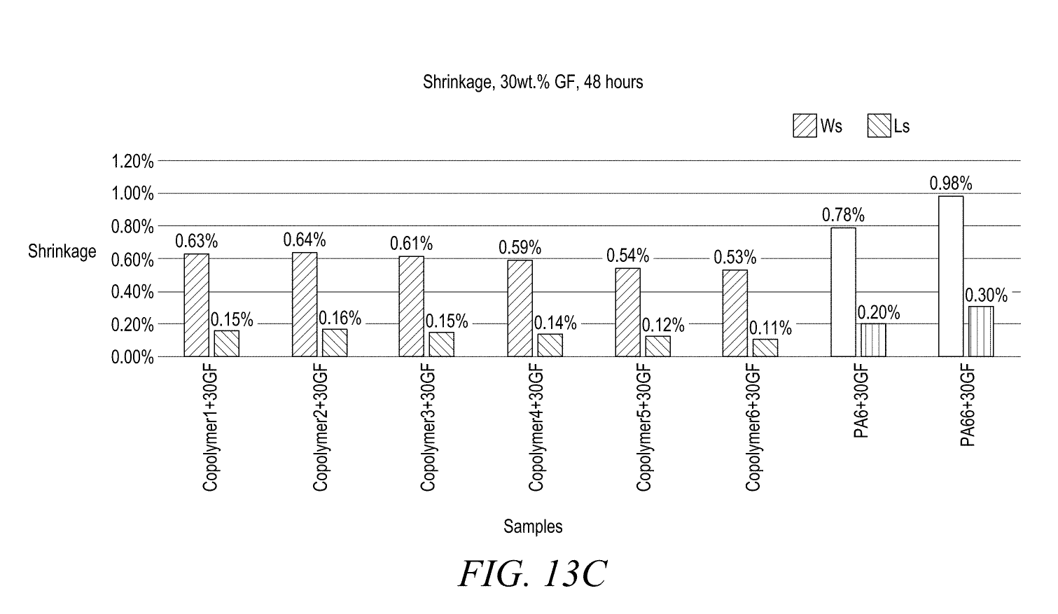

FIGS. 13A, 13B, and 13C give the initial, 24 hours and 48 hours shrinkage of 30 wt. % glass fiber filled PA6/66 copolymer with 6 different PA66 content. 30 wt. % glass fiber filled PA6 and 30 wt. % glass fiber filled PA66 were used for comparison. For the 30 wt. % glass fiber filled PA6/66 copolymer, higher PA66 content resulted in lower shrinkage. The 30 wt. % glass fiber filled PA6/66 copolymer with 6 different PA66 content shows lower shrinkage compared with 30 wt. % glass fiber filled PA6 and 30 wt. % glass fiber filled PA66. 24 hours shrinkage is slightly higher than initial shrinkage. Generally, 48 hours shrinkage is similar to 24 hours shrinkage. PA66 shows the highest shrinkage among the tested samples.

While this disclosure has been described as relative to exemplary designs, the present disclosure may be further modified within the spirit and scope of this disclosure. Further, this application is intended to cover such departures from the present disclosure as come within known or customary practice in the art to which this disclosure pertains.

1. A polymeric base composition for use in manufacturing a finished article via melt processing, said polymeric base composition comprising:
at least one polyamide 6/66 copolymer polymerized from caprolactam and adipic acid/hexamethylenediamine monomers and including between 70 mol. % and 99 mol. % monomers based on caprolactam and between 1 mol. % and 30 mol. % monomers based on adipic acid and hexamethylenediamine, based on the total moles of caprolactam and adipic acid/hexamethylenediamine monomers; and
at least one reinforcement component.

2. The polymeric base composition of claim 1, wherein said polyamide 6/66 copolymer includes between 70 mol. % and 96 mol. % monomers based on caprolactam and between 4 mol. % and 30 mol. % monomers based on adipic acid and hexamethylenediamine, based on the total moles of caprolactam and adipic acid/hexamethylenediamine monomers.

3. The polymeric base composition of claim 1, wherein said polyamide 6/66 copolymer has a relative viscosity (RV) of 2.0 to 3.0 as determined by a viscometer according to ASTM D798.

4. The polymeric base composition of claim 1, wherein said polyamide 6/66 copolymer has a melt point, measured by Differential Scanning calorimetry (DSC) using ASTM D3418, between 190° C. and 225° C.

5. The polymeric base composition of claim 1, wherein said polyamide 6/66 copolymer has a crystallization temperature, measured by Differential Scanning calorimetry (DSC) using ASTM D3418, between 150° C. and 170° C.

6. The polymeric base composition of claim 1, wherein said polyamide 6/66 copolymer has a crystallization time, as determined by differential scanning calorimetry (DSC) using ASTM E2070, between 1 min and 14 min.

7. The polymeric base composition of claim 1, wherein said at least one reinforcement component comprises glass fibers.

8. The polymeric base composition of claim 1, wherein said at least one reinforcement component comprises carbon fibers.

9. The polymeric base composition of claim 1, wherein said reinforcement component is present in an amount between 5% and 85%, based on the total weight of the polyamide 6/66 copolymer and said reinforcement component.

10. An article formed via a melt processing method, said article comprising:
at least one polyamide 6/66 copolymer polymerized from caprolactam and adipic acid/hexamethylenediamine monomers and including between 70 mol. % and 99 mol. % monomers based on caprolactam and between 1 mol. % and 30 mol. % monomers based on adipic acid and hexamethylenediamine, based on the total moles of caprolactam and adipic acid/hexamethylenediamine monomers; and
at least one reinforcement component.

11. The article of claim 10, wherein said polyamide 6/66 copolymer includes between 70 mol. % and 96 mol. % monomers based on caprolactam and between 4 mol. % and 30 mol. % monomers based on adipic acid and hexamethylenediamine, based on the total moles of caprolactam and adipic acid/hexamethylenediamine monomers.

12. The article of claim 11, wherein a surface of said article has a measured gloss at a 60° angle of incidence according to ASTM D-523 between 50.0 and 95.0.

13. The article of claim 11, wherein said article has a conditioned toughness determined according to ASTM D-256 at 23° C. between 180 J/m and 500 J/m.

14. The article of claim 11, wherein said article has a dry condition toughness determined according to ASTM D-256 at 23° C. between 30 J/m and 250 J/m.

15. The article of claim 11, wherein said article has a measured initial shrinkage vertical to the flow direction (Ws) according to ASTM D-955 between 0.45% and 1.2%.

16. The article of claim 11, wherein said article has a measured initial shrinkage parallel to the flow direction (Ls) according to ASTM D-955 between 0.10% and 1.0%.

17. The article of claim 11, wherein said at least one reinforcement component comprises glass fibers.

18. The article of claim 11, wherein said at least one reinforcement component comprises carbon fibers, and said article has a flexural modulus according to ASTM D 790 between 18000 and 30000 MPa.

19. The article of claim 11, wherein said at least one reinforcement component comprises carbon fibers, and said article has a Young's modulus according to ASTM D 638 between 20000 and 40000 MPa.

20. The article of claim 11, wherein said at least one reinforcement component comprises carbon fibers, and said article has a tensile strength according to ASTM D 638 between 500 and 3000 MPa.
